(19) United States
(12) Patent Application Publication
(10) Pub. No.: US 2013/0268764 A1
(43) Pub. Date: Oct. 10, 2013

(54) DATA EVENT AUTHENTICATION AND VERIFICATION SYSTEM

(71) Applicants: Juan Valdes, Henderson, NV (US); Brian Parvin, Aliso viego, CA (US); Steve Tulk, Coto De Caza, CA (US)

(72) Inventors: Juan Valdes, Henderson, NV (US); Brian Parvin, Aliso viego, CA (US); Steve Tulk, Coto De Caza, CA (US)

(21) Appl. No.: 13/442,055

(22) Filed: Apr. 9, 2012

(51) Int. Cl. H04L 9/32

(52) U.S. Cl. 713/178

(57) ABSTRACT

An authentication system for authentication and verification of data provides verification that stored data has not been tampered with or otherwise altered. The authentication system may be configured to interoperate with a variety of other systems, such as various data storage and retrieval systems. In this manner, the authentication and verification services can be used to enhance various systems with data verification capabilities. The authentication system may sign and verify signatures for data. In addition, the authentication system may be configured to verify the time of a data event, the timeliness of the data event, or both.

### BACKGROUND OF THE INVENTION

1. Field of the Invention

The invention relates to verification systems and in particular to an authentication system and method for confirming the time and accuracy of action records, event records, and other records from a variety of sources.

2. Related Art

Collaborative tasks allow labor or effort from multiple parties to be expended towards a particular goal. Though this decreases the time required to complete the goal, managing the efforts of multiple parties becomes an increasingly difficult task as more parties become involved.

One traditional way of collaborating is via group email or other messaging where the appropriate parties to the emails take action as needed. This is highly informal and thus the goal of the collaboration could be hindered or even lost, such as if the group messages veer off topic. In addition, communication may take place outside the group messages and thus never be captured.

Another traditional way of collaborating is via a paper-based system, such as a checklist system where individual parties mark their responsibilities as complete. Other participants can then evaluate the checklist to determine when or if their work should begin.

From the discussion that follows, it will become apparent that the present invention addresses the deficiencies associated with the prior art while providing numerous additional advantages and benefits not contemplated or possible with prior art constructions.

### SUMMARY OF THE INVENTION

An authentication system for authenticating and verifying data is disclosed herein. The authentication system may be used to authenticate and verify data of various types, including data event data as disclosed herein. The authentication system is advantageous in that it may be used with various data storage and retrieval systems to enhance such systems with data verification capabilities. The authentication and verification features provided by the authentication system may be used to verify that stored data event data has not been tampered with or otherwise altered. In addition, the time and/or timeliness of data event data can be confirmed or verified with the authentication system herein. This is highly advantageous where accuracy and timeliness is important.

The authentication system may have various configurations. For instance, in one embodiment, an authentication system might comprise an input device configured to receive data event data having a timestamp, an authenticator configured to compare the timestamp to a time value, and a signer configured to generate an electronic signature from at least the data event data. The signer will typically generate the electronic signature only if the timestamp is within a predefined period of time of the time value. An output device may be configured to send the electronic signature to an external device, such as to acknowledge the receipt and/or authentication of the data event data.

The authentication system may also include a storage device configured to store the electronic signature, a clock configured to provide the time value, or both. It is noted that the input device and output device may be a communication interface configured to communicate the data event data and the electronic signature through one or more communication links.

The signer may be further configured to generate a hash value for the data event data and to generate the electronic signature using at least the hash value. It is also noted that the authenticator may be configured to validate one or more user identifiers received at the input device. In such case, the signer may be configured to generate the electronic signature only if the user identifiers are valid.

In another exemplary embodiment, an authentication server may be provided. In such an embodiment, the authentication server may comprise one or more communication interfaces configured to receive data event data from one or more client devices, and one or more processors configured to execute machine readable code to provide authentication and verification services for the data event data.

The machine readable code may comprise instructions to compare a timestamp of the data event data to a time value, generate one or more electronic signatures from the data event data if the timestamp is within a predefined period of time of the time value, store the electronic signature, and transmit the electronic signature to the client devices via the communication interfaces.

One or more storage devices configured to store the machine readable code may be included as part of the authentication server well. It is noted that the storage devices may be further configured to store the electronic signatures, the data event data, or both. In addition, a clock configured to provide the time value may be included with the authentication server.

The machine readable code may be configured in various ways. For instance, the machine readable code may further comprise instructions to generate one or more hash values from the data event data, whereby the electronic signatures are generated from at least the hash values.

The machine readable code may also comprise instructions to verify the data event data in various ways. For example, the data event data may be verified by retrieving the stored electronic signature for the data event data and transmitting the stored electronic signature to the client devices for comparison at the client devices. Alternatively, the data event data may be verified by comparing an unconfirmed signature received from the client devices with the stored electronic signature for the data event data.

Various data authentication and verification processes are disclosed herein as well. For example, in one embodiment a method of authenticating data with an authentication system may comprise receiving data event data at a communication interface of the authentication system, extracting a timestamp from the data event data, and comparing the timestamp to a time value to determine if the timestamp is within a predefined period of time of the time value.

An electronic signature may be generated for the data event data if the timestamp is within the predefined period of time, and the electronic signature may then be stored on a storage device of the authentication system. It is noted that if one or more user identifiers are provided to the authentication system, the electronic signature may only generated if the user identifiers are valid (e.g., are valid username/password combinations).

The electronic signature may subsequently be retrieved from the storage device to verify that the data event data has not been altered. For example, the electronic signature may be compared to an unconfirmed signature to verify the data event data; with the data event data being considered verified if the unconfirmed signature matches the stored electronic signature. It is noted that a current time may be retrieved from a clock and the current time may be used as the time value.

It is noted that an identifier indicating that the timestamp is outside the predefined period of time may be stored if the timestamp is outside the predefined period of time. In such case, the electronic signature will not be generated for the data event data.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram illustrating a traditional data storage and retrieval system;

FIG. 2 is a block diagram illustrating a data storage and retrieval system having an authentication system;

FIG. 3 is a block diagram illustrating components of an exemplary authentication system;

FIG. 4A is a block diagram illustrating an authentication system in an exemplary environment of use;

FIG. 4B is a block diagram illustrating an authentication system in an exemplary environment of use;

FIG. 5 is a block diagram illustrating components of an exemplary authentication system;

FIG. 6 is a flow diagram illustrating an exemplary authentication process; and

FIG. 7 is a flow diagram illustrating an exemplary verification process.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the authentication system disclosed herein allows a wide variety of data to be quickly and easily signed and subsequently authenticated. This is advantageous in that the authentication system verifies that the data has not been altered after the fact. In addition, the authentication system prevents users who have “signed” data from later denying that they did so. In one or more embodiments, the authentication system may include an electronic or software interface to permit interoperability or integration with other systems. This is advantageous in that it allows a variety of systems to be enhanced with the signature and authentication capabilities provided by the authentication system.

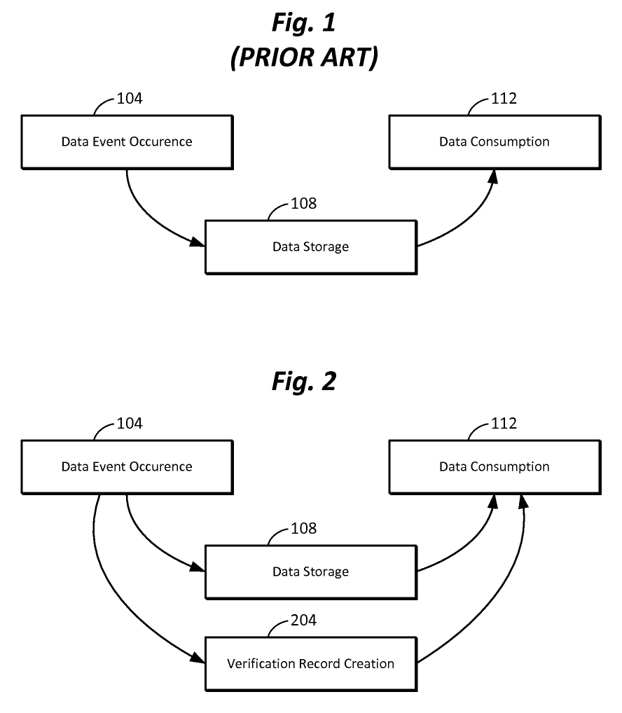

Traditional data recording and retrieval systems, such as databases and other data stores, record data in a storage device for later use. With reference to FIG. 1, the creation of data that should be stored or recorded has been shown as a data event 104. This data is stored in a storage step 108 for later consumption at a step 112. Though this works well for data storage and retrieval, there are multiple avenues by which the stored data may be undesirably altered, either accidentally or intentionally. For instance, an administrator or other personnel with authority to access the storage device may alter the stored data. In addition, an unauthorized user could alter the stored data. In any case where stored data has been altered, it may be difficult or impossible to determine that the stored data has been altered or what alterations have been made.

FIG. 2 is a flow diagram illustrating data storage and retrieval as generally may occur with the authentication system herein. As can be seen, the occurrence of a data event at step 104 creates data that should be recorded or stored. As described above, the storage of this data occurs at step 108 for later retrieval/use by a data consumer at step 112. With the authentication system however, verification records are generated at a step 204. As will be detailed further below, the verification records may be used by data consumers, such as at step 112, to verify the authenticity of the data stored at step 108. Such verification may include verification of the time a data event occurred, as will also be described further below.

As can also be seen from FIG. 2, the ability to verify the authenticity of data may occur independent from the storage of the data. This is highly advantageous in that it allows any alteration to stored data to be detected, even if the alteration came about as a result of a flaw or error in the data storage and retrieval system, or an authorized user or administrator made the alteration. As a result, data consumers can trust that the stored data has not been altered. In record keeping tasks, especially those involving multiple record keepers and/or mission critical data, this is highly advantageous.

As stated above, the authentication system may be configured to interoperate with or integrate with a variety of data storage and retrieval systems. For example, authentication services provided by the authentication system may be used with existing systems for workflow/process tracking, project management, human resources, training, compliance, accounting, and the like.

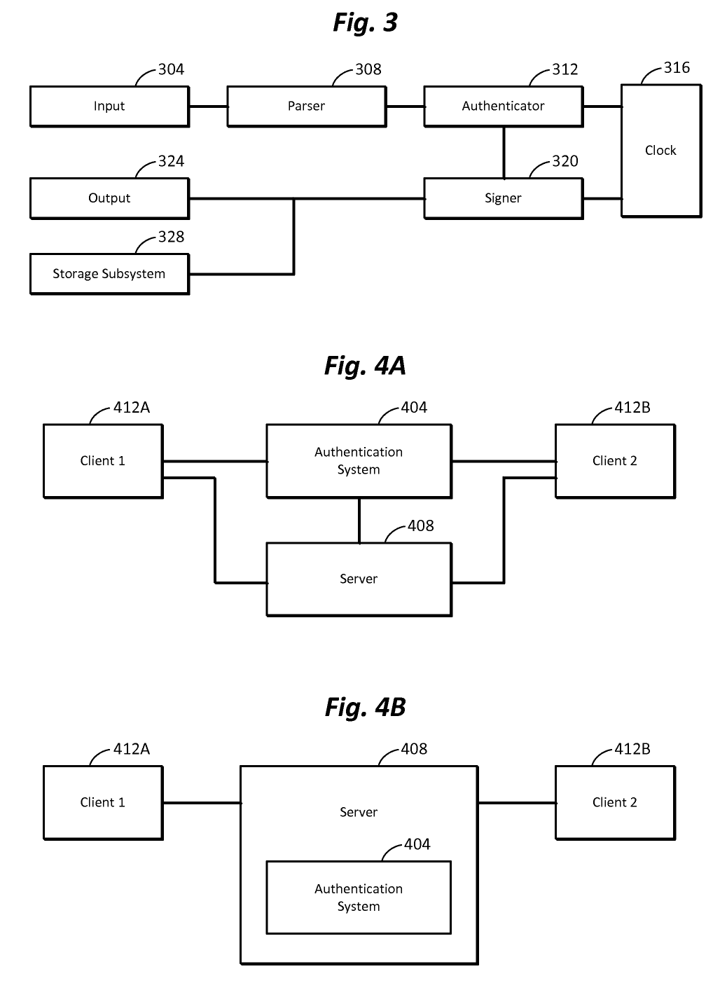

The authentication system will now be described with regard to FIG. 3, which is a block diagram illustrating components of an exemplary authentication system. As can be seen, the authentication system may comprise one or more inputs 304 and one or more outputs 324 to respectively receive and transmit data. It is noted that the components of the authentication system may be implemented in hardware, software, or both. For instance, either or both the input 304 and output 324 could be a hardware or software interface in one or more embodiments. To illustrate, in one exemplary hardware embodiment, the input 304 and output 324 might be an Ethernet, USB, fiber channel, Wi-Fi, Bluetooth, or other communication interface/port. It is contemplated that the input 304 and output 324 may utilize various wired or wireless technologies now known or later developed. In software embodiments, the input 304 and output 324 may be an accessor (e.g., getter or setter) function or other function providing access to the functionality of the authentication system. It is noted that the input 304 and output 324 could also be a property in some embodiments.

One benefit of having a versatile input 304 and output 324 is that it permits the authentication system to be integrated or interoperate with various other data storage and retrieval systems. For example, data created by or resulting from a data event may be easily and conveniently delivered to the authentication system via the input 304 in various data formats and through different communication technologies. In one or more embodiments, the authentication system may provide a predefined protocol in which to communicate data with other systems. A receipt or acknowledgment may then be returned by the authentication system via the output 324, as will be described further below.

In some embodiments, an optional parser 308 may be provided to process data received via the input 304. In one or more embodiments the parser 308, if provided, may be configured to extract individual fields or subsets of data from this input data. For instance, in one or more embodiments, the parser 308 may separate usernames and passwords so that they may be used to authorize a user (that has entered a valid username and password). The parser 308 may also separate data to be authenticated from other data received at the input 304. In this manner, only the desired data may undergo the authentication process provided by the authentication system. This is advantageous in that it allows data to be categorized into authenticated data and non-authenticated data, with alterations being permitted to non-authenticated data (since it will typically be less important that authenticated data).

To illustrate, in one embodiment, the authentication system may be configured to receive input data at its input 304. The input data may include data event data and one or more user identifiers (e.g., usernames and passwords). The parser 308 may then extract or separate the data event data and user identifiers from the input data for subsequent processing. One benefit of a user identifier is that it permits the authentication system to generate a verification record for the received data that is associated with the user identified by the user identifier. In addition, it is noted that if a user identifier received at the input 304 is invalid, the authentication system will typically not begin the authentication process thereby ensuring that authenticated data is not associated improperly with invalid or unknown users.

As can be seen, an authenticator 312 may next receive the data originally received at the input 304. The authenticator 312 may be configured to verify user identifiers, such as described above. For instance, if a username or password (or other user identifier) is incorrect or invalid, the authenticator 312 may deem such user identifier as invalid, and discontinue the authorization process. The authenticator 312 may query a data storage device to compare and validate user identifiers. If a valid user identifier is received, then the authentication process may continue on the data event data, as will now be described.

As discussed above, the data event data is data resulting from a data event that should be authenticated so that data consumers can verify that the data has not been tampered with or otherwise altered. Data events may be various occurrences that result in the creation of data. For example, in a project management or workflow management system, a data event might be the marking of a task as complete, or updating the status of a task. In this example, the data event data would be a task completion identifier/flag or the status update.

Data events and thus data event data may include or be associated with a time. For example, the time a data event occurred may be included in its resulting data event data, such as in the form of a timestamp. The timestamp may include a date and/or time, and may be capable of representing time in various increments include sub-second increments.

In some embodiments, the authenticator 312 may verify the timestamp of data event data prior to continuing the authentication process. Typically, this occurs by comparing the timestamps to another time value. For example, if the timestamp falls within a predefined period of this time value, the authentication process may continue. If not, then the authentication process may be stopped. Verification of timestamps in this manner is advantageous in that it helps ensure the timeliness of data events. In some situations, such as in scientific experiments, surveys, and other data gathering activities, the timeliness of data is crucial (such as to ensure the accuracy of measurements or responses). If the timestamp of data event data indicates that the data is “too old”, this feature allows the authentication system to avoid or prevent such data from being authenticated. It is noted that such functionality may be implemented in various ways. For example, data event data that is not timely (e.g., beyond the predefined time threshold) may still be authenticated, but may be flagged as suspect.

As can be seen from FIG. 3, a clock 316 may be included or utilized by the authentication system to verify timestamps. In one or more embodiments, the clock 316 may be configured to keep current time, though it is contemplated that the clock may be set as desired. In operation, the authenticator 312 may query the clock 316 for a time value and compare this value to the timestamp of incoming data event data to verify the timeliness of the data event data. The authenticator 312 may then determine if the difference in time between the time value from the clock 316 and the timestamp are within a predefined period, and proceed accordingly as described above. It is noted that the predefined period may be user definable in one or more embodiments. In addition, particular types of data event data could have their own predefined periods associated therewith. In this manner, timeliness could be more strictly enforced for certain types of data events. For example, the importance of timely entry of contact or correspondence information might be less than that of experimental measurements, and thus the predefined period for contact/correspondence information may be relatively larger.

The authentication system may also include a data signer 320, which is generally configured to generate an electronic signature for the data it receives. The electronic signatures are important in the verification of data event data. To verify that data event data has not been altered the electronic signature of the data can be compared to a stored electronic signature for the same data that was generated earlier by the data signer 320. If the signatures match, the data event data is considered unaltered. If the signatures do not match, then the data event data has been altered.

The data signer 320 will typically generate an electronic signature for the data event data received via the input 304 of the authentication system. In this manner, any alteration to this data event data can be later detected. If a timestamp or one or more user identifiers are included in the data event data for example, then the electronic signature would apply to the data event data including its timestamp and/or user identifiers. This is advantageous in that it ensures that all parts of the data event data can be later verified.

It is noted that user identifiers may be received as part of data event data or separately. For example, one or more users may be identified in data event data where they have participated in the creation or are otherwise associated with the data event data. To illustrate, User X may be identified as completing a task in the data event data. User identifiers received in this way would be authenticated along with the remainder of the data event data.

User identifiers received separately from the data event data will typically not be authenticated, and may instead be used to verify and associate particular users with authenticated data event data. For example, User X may be identified as the creator of data event data if the user identifier properly identifies (e.g., via a valid username and password combination) User X. In addition, as will be described below, a properly identified user may sign the data event data signifying (in most situations) that he or she was the one that submitted the data event data for authentication.

In operation, the data signer 320 may generate a hash value that represents the data event data. Various ways of generating a hash may be employed by the data signer 320 including, MD5 and SHA1. This hash value may then be used as the electronic signature. Alternatively or in addition, the hash value itself may be signed, such as by a user that is identified in any user identifier received by the authentication system along with the data event data. In one or more embodiments for example, this may be accomplished by signing the hash value with a properly identified user's public key, in a public key infrastructure system.

The electronic signature may be shared or communicated via the output 324 of the authentication system. For example, the electronic signature may be shared with a data storage and retrieval system that stores the electronic signature. It is contemplated also that the authentication system may include its own storage capabilities for electronic signatures. For example, the authentication system may have a storage subsystem 328 that stores electronic signatures generated by the data signer 320. The electronic signatures may subsequently be retrieved to verify data event data. For instance, a data consumer may query the storage subsystem 328 for the electronic signature of particular data event data. This electronic signature may be compared to a signature for the same data event data generated by the data consumer to verify the data event data.

The authentication system may operate in conjunction with other systems, such as data storage and retrieval systems, in various ways. FIGS. 4A-4B illustrate some exemplary arrangements of the authentication system with other systems. As can be seen, a data storage and retrieval system having a client/server configuration is shown in the figures. In operation, one or more clients 412 may provide and/or request data to/from a server 408. The server 408 may have or have access to one or more storage devices, such as magnetic, optical, flash, or other storage, to retrievably store data from and for the clients 412.

The server 408 and clients 412 may be configured to interoperate with one another for a particular purpose. For example, the server 408 and clients 412 may respectively execute server and client software comprising machine readable code to provide a particular functionality. To illustrate, in one exemplary circumstance, the clients 412 may be database clients that access a database provided via the server 408. The clients 412 may thus store and retrieve data in an organized manner via the server 408. For instance, the data may be stored in database tables having one or more predefined fields. This permits a variety of data storage and retrieval services to be implemented, such as data storage and retrieval for workflow/process tracking, project management, human resources, training, compliance, accounting, and the like as discussed above.

FIG. 4A illustrates a first exemplary configuration where the authentication system 404 operates independent from the server 408 of a data storage and retrieval system. As can be seen by the illustrated communication links, the clients 412 may communicate directly with both the server 408 and the authentication system 404, and the authentication system may communicate directly with the server. It is noted that these communication links may be various wired or wireless links and may span one or more local or wide area networks (including the Internet). In this manner, communication with the authentication system 404 may occur across variable distances. Though shown as having two clients 412, it is contemplated that the authentication system 404 may operate with an arbitrary number of clients 412.

In operation, data event data may be transmitted from a client 412 to the authentication system 404. The resulting electronic signature (generated by the authentication system 404) may then be stored for later retrieval. As stated above, the electronic signature may be stored at various locations. For instance, the electronic signature may be transmitted to the server 408 for storage, or be stored by the authentication system 404 itself. Alternatively or in addition, the electronic signature may be transmitted to the client 412. The client 412 may then relay the electronic signature to the server 408 for storage, or alternatively may store the electronic signature itself. It is typically more desirable for the authentication system 404 or server 408 to store the electronic signature directly however, since this avoids the risk of the electronic signature being tampered with.

It is contemplated that the authentication system 404 may also store the data event data. Typically however, the server 408 of the data storage and retrieval system may store the data event data. In one or more embodiments, the authentication system 404 may relay the data event data it receives to the server 408 along with the data's electronic signature. The server 408 may then store both. In this manner, the server 408 receives both the data event data and its electronic signature directly, reducing the risk of tampering of the data or signature before it is stored. It is contemplated that the electronic signature may be incorporated into the data event data and stored as part of the data event data in some embodiments. The electronic signature can then be retrieved along with the data event data.

To verify stored data event data, the data's electronic signature may be retrieved by a data consumer. The electronic signature may be retrieved at the same time or along with the data event data. For example, a query for particular data event data may automatically return the data event data's electronic signature along with the data event data itself. It is contemplated that the electronic signature may be retrieved separately in some embodiments. For example, a data consumer may request the electronic signature for data event data by identifying the data event data (such as via a unique identifier) in a query. It is noted that the data consumer may be the server 408, client 412, or other device/user that wishes to access the data event data. Therefore, the server 408 may verify the data event data before transmitting it to a client 412, a client may verify the data event data itself, or both. As will be discussed further below, the retrieved electronic signature may be compared to a signature generated by the data consumer to verify that the data event data has not been tampered with or otherwise altered.

Referring now to FIG. 4B, it can be seen that the authentication system 404 may be integrated into a server 408. For instance, the authentication system 404 may comprise machine readable code executable by the server 408 to provide the functionality disclosed herein. The server 408 may also provide any data storage and retrieval services it has already been (or will be) configured to provide. The authentication system 404 may also have or access hardware elements. For example, the authentication system 404 may include a hardware based data signer and/or clock, such as described above with regard to FIG. 3.

In the embodiment of FIG. 4B, the clients 412 may communicate with the server 408 and, in turn, the server may utilize the authentication/verification services provided by its internal authentication system 404. For instance, data event data from a first client 412 may be received by the server 408 and passed to the authentication system 404. The server 408 may then store the resulting electronic signature. It is contemplated that an acknowledgment or even a copy of the electronic signature may be returned to the client 412. To verify data event data, the previously stored electronic signature may be provided when a client 412 next accesses the data event data. The client 412 (or other data consumer) may then verify the data event data with the electronic signature.

As alluded to above, the authentication system 404 is capable of verifying data event data regardless of the type or other characteristics of the data consumer. As described above for example, the data consumer may be a server 408 or a client 412. In addition, as shown in FIGS. 4A-4B, data event data may be verified on different clients 412 regardless of the source of the data event data. For instance, the same data event data could be verified at a first client 412A, second client 412B, or other data consumer.

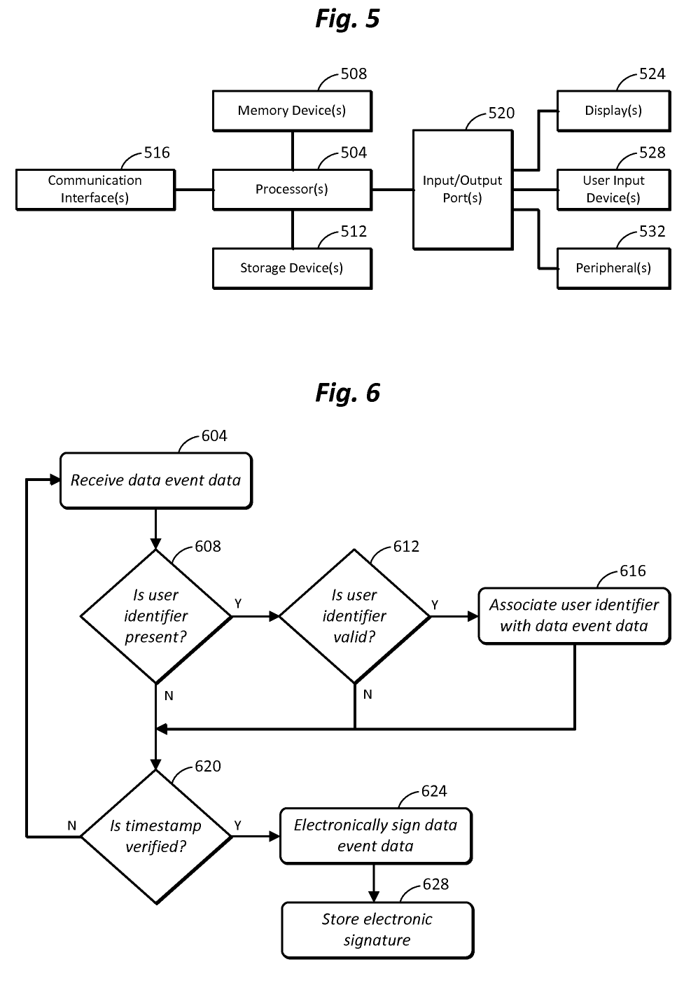

FIG. 5 is a block diagram illustrating an exemplary server, which may implement the authentication system. Though described with reference to the term server, it is noted that a variety of similarly configured computing devices (e.g., desktop computers, network appliances) could also implement the authentication system.

As can be seen from FIG. 5, the server may comprise one or more processors 504, memory devices 508, storage devices 512, and communication interfaces 516. The server may also include one or more input/output ports 520 to communicate data with other devices, such as one or more display devices 524 (e.g., monitors), user input devices 528 (e.g., keyboards, mice, touch interfaces), and other peripheral devices 532 (e.g., printers, scanners). The user input devices 528 allow a user to configure and control the server, while the display devices 524 provide feedback to the user during such configuration and control. The user input devices 528 and display devices 524 may also be used to query the status of the authentication system, and to review data event data and/or electronic signatures stored on the server as well.

The one or more processors 504 may be configured to provide the authentication system functionality disclosed herein by executing one or more instructions. For example, one or more of the components of the authentication system, such as the parser, authenticator, and data signer described above with regard to FIG. 3 may be implemented in one or more instructions executable by the processors 504. It is contemplated that the instructions or machine readable code may be hardwired into the processors 504, be stored on a memory or storage device 508, 512, or both. A processor 504 may be a microprocessor, integrated circuit, ASIC or the like.

Generally speaking, the memory devices 508 will be used for short term or temporary storage of data during the execution of the authentication system. In contrast, the storage devices 512 may be used for permanent or more permanent data storage. Because of this, data event data and electronic signatures therefor may be stored on the storage devices 512. The storage devices 512 may utilize various storage technologies, such as magnetic, optical, flash, or other storage technologies. It is contemplated that the storage devices 512 may be remote from the server in some embodiments and accessible to the server via one or more communication links.

The communication interfaces 516 will typically be used for external communication with other devices, such as clients. The communication interfaces 516 may be configured to communicate via various wired or wireless communication links and may also utilize various standard or proprietary communication protocols. The communication interfaces 516 may also provide encryption and/or compression to respectively secure and increase efficiency of data transmissions to and from the server.

In operation, the communication interfaces 516 may be used to receive data event data from other devices, such as clients of the server. The communication interfaces 516 may also be used to transmit data event data to other devices, such as the server's clients. In addition, electronic signatures may also be transmitted via the communication interfaces 516. For instance, a query for particular data event data from a client may result in a transmission of the data event data from the server to that client along with the electronic signature for that data.

Further details regarding the authentication process provided by the authentication system will now be described with regard to the flow diagram of FIG. 6. It is noted that some of the process steps in the following may be performed in various sequences other than that illustrated.

At a step 606, data event data may be received from an external source, such as a client. At a decision step 608, it may be determined if a user identifier has been received as well. For example, an incoming data stream may be parsed to determine if any user identifiers have been received along with the data event data. If so, at a decision step 612, it may be determined if the user identifier properly identifies a valid user. For example, it may be determined if the user identifier is a valid username and password combination. If so, the user identified in the user identifier may be associated with the data event data, such as by being listed as the creator or authenticator of the data event data. If, at decision step 608, no user identifier is received (and some embodiments of the authentication system may not support user identifiers in this manner), then the data event data may still be signed, as will be described in the following.

At a decision step 620, the validity of the data event data's timestamp may be verified. As discussed above, this may occur by comparing the data's timestamp to another time reference, such as a current time provided by a clock accessible to the authentication system. If the timestamp is within a predefined time period of the reference time, then the timestamp may be deemed valid at decision step 620. If not, the timestamp may be deemed invalid and the authentication process may be halted. As shown in FIG. 6 for example, the process may return to step 604 to await additional data event data.

If the timestamp is valid, then the data event data may be electronically signed at step 624, with the resulting electronic signature being stored at step 628. The electronic signing process may utilize a hash of the data event data in some embodiments. For example, a hash value may be first calculated for the data event data. The hash value may then be used to generate the electronic signature or be incorporated into the electronic signature. At the signing step 624, if a user has been associated with the data event data at step 616, then that user's credentials (such as his or her public key) may be used to generate the electronic signature. Alternatively, at step 624, the electronic signature may be generated with other credentials. For example, the authentication system may have one or more of its own public keys or the like for use in generating electronic signatures.

The authentication services provided by the authentication system are both versatile and useful. To illustrate, in a scientific environment, such as a laboratory or manufacturing plant, individual technicians may generate and transmit data event data to the authentication system for electronic signing and subsequent verification. Data event data may be data signifying the completion/status of a test or other task, measurements or other characteristics of such test/task, and the like. Since the data event data may be timestamped (such as by the technicians' client devices), the timeliness of the data event data can be verified. This is in addition to the ability to verify that the data event data has not been altered after the fact. Both these capabilities are highly advantageous in monitoring the activity of technicians, especially where regulatory or other requirements must be met. With the authentication system, a regulator or other body may easily see that the data event data recorded by a data storage and retrieval system is timely and has not been altered.

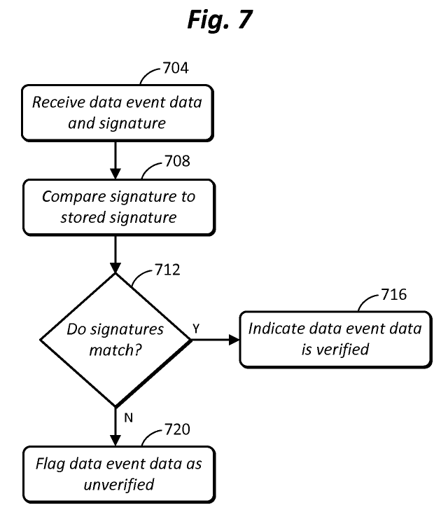

FIG. 7 is a flow diagram illustrating the verification of data event data. Verification may begin with receipt of a request for data event data verification. For instance, at a step 704, data event data to be verified may be received along with an unconfirmed signature. This may signify to the authentication system that a verification request is being made. Alternatively, in some embodiments, a particular command or instruction may be transmitted to the authentication system to signify a verification request.

The unconfirmed signature will typically be generated by the client or other device that is transmitting the data event data to the authentication system. Typically, the client and authentication system will be configured to generate signatures according to the same predefined process. In this manner, the same electronic signature should be generated for identical data event data, thus allowing the electronic signatures to be used to verify that the data event data has not been altered.

At a step 708, the unconfirmed signature may be compared to the electronic signature for the data event data previously generated and stored by the authentication system. At a decision step 712 if the unconfirmed signature is a match for the stored electronic signature. If so, the data event data received at step 704 may be deemed verified at a step 716. If not, the data event data may be flagged at a step 720 to alert the client or other device requesting verification that the data event data can not be verified and thus should be treated as suspect. A verification or warning identifier may be transmitted from the authentication system to the client to signify the same.

It is contemplated that, in some embodiments, the authentication system may simply verify that the unconfirmed signature is valid for the associated data event data. For example, the authentication system may generate a new signature using the data event data. If this new signature matches the unconfirmed signature, the data event data may be considered verified (i.e., unaltered).

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. An authentication system comprising:
an input device configured to receive data event data, the data event data having a timestamp;
an authenticator configured to compare the timestamp to a time value;
a signer configured to generate an electronic signature from at least the data event data, wherein the signer generates the electronic signature only if the timestamp is within a predefined period of time of the time value; and
an output device configured to send the electronic signature to an external device.

2. The authentication system of claim 1 further comprising a storage device configured to store the electronic signature.

3. The authentication system of claim 1 further comprising a clock configured to provide the time value.

4. The authentication system of claim 1, wherein the input device and output device are a communication interface configured to communicate the data event data and the electronic signature through one or more communication links.

5. The authentication system of claim 1, wherein the signer is further configured to generate a hash value for the data event data and to generate the electronic signature using at least the hash value.

6. The authentication system of claim 1, wherein the authenticator is configured to validate one or more user identifiers received at the input device.

7. The authentication system of claim 6, wherein the signer is configured to generate the electronic signature only if the one or more user identifiers are valid.

8. An authentication server comprising:
one or more communication interfaces configured to receive data event data from one or more client devices;
one or more processors configured to execute machine readable code to provide authentication and verification services for the data event data, the machine readable code comprising instructions to:
compare a timestamp of the data event data to a time value;
generate one or more electronic signatures from the data event data if the timestamp is within a predefined period of time of the time value;
store the electronic signature; and
transmit the electronic signature to the one or more client devices via the one or more communication interfaces; and
one or more storage devices configured to store the machine readable code.

9. The authentication server of claim 8, wherein the one or more storage devices are further configured to store the one or more electronic signatures.

10. The authentication server of claim 8, wherein the one or more storage devices are further configured to store the data event data.

11. The authentication server of claim 8 further comprising a clock configured to provide the time value.

12. The authentication system of claim 8, wherein the machine readable code further comprises instructions to generate one or more hash values from the data event data, whereby the one or more electronic signatures are generated from at least the one or more hash values.

13. The authentication server of claim 8, wherein the machine readable code further comprises instructions to verify the data event data by retrieving the stored electronic signature for the data event data and transmitting the stored electronic signature to the one or more client devices.

14. The authentication server of claim 8, wherein the machine readable code further comprises instructions to verify the data event data by comparing an unconfirmed signature received from the one or more client devices with the stored electronic signature for the data event data.

15. A method of authenticating data with an authentication system comprising:
receiving data event data at a communication interface of the authentication system;
extracting a timestamp from the data event data;
comparing the timestamp to a time value to determine if the timestamp is within a predefined period of time of the time value;
generating an electronic signature for the data event data if the timestamp is within the predefined period of time;
storing the electronic signature on a storage device of the authentication system; and
retrieving the electronic signature from the storage device to verify that the data event data has not been altered.

16. The method of claim 15 further comprising retrieving a current time from a clock and utilizing the current time as the time value.

17. The method of claim 15 further comprising receiving an unconfirmed signature for the data event data and comparing the electronic signature to the unconfirmed signature to verify that the data event data has not been altered.

18. The method of claim 15 further comprising storing an identifier indicating that the timestamp is outside the predefined period of time if the timestamp is outside the predefined period of time.

19. The method of claim 15 further comprising receiving and validating one or more user identifiers, wherein the electronic signature is generated only if the one or more user identifiers are valid.

20. The method of claim 15 further comprising generating the time value with an internal clock of the authentication system.
